(19) United States
(12) Patent Application Publication
(10) Pub. No.: US 2006/0267912 A1
(43) Pub. Date: Nov. 30, 2006

(54) Shift register and display device having the same, and method thereof

(76) Inventors: Jong-Hwan Lee, Anyang-si (KR); Do-Gi Lim, Cheonan-si (KR); Kye-Hun Lee, Suwon-si (KR)

Correspondence Address: CANTOR COLBURN, LLP, 55 GRIFFIN ROAD SOUTH, BLOOMFIELD, CT, 06002, US

(21) Appl. No.: 11/415,133

(22) Filed: May 1, 2006

(30) Foreign Application Priority Data
May 30, 2005 (KR) 2005-45566

(51) Int. Cl. G09G 3/36

(52) U.S. Cl. 345/100

(57) ABSTRACT

A shift register invention includes a plurality of stages outputting a plurality of output signals, in sequence. Each of the stages includes a driving part and a discharging part. The driving part includes a driving transistor. The driving transistor has a control electrode, a first electrode, a second electrode and a channel layer. The control electrode receives one of a start signal or an output signal of a previous stage. The first electrode receives a clock signal. The second electrode outputs an output signal of a present stage. The channel layer has a different length from a channel layer of a driving transistor of the previous stage. The discharging part discharges the output signal of the present stage based on an output signal of a next stage, therefore improving the electrical characteristics of the shift register.

The present application claims priority to Korean Patent Application No. 2005-45566, filed on May 30, 2005, and all the benefits accruing therefrom under 35 U.S.C. §119, and the contents of which in its entirety are herein incorporated by reference.

### BACKGROUND OF THE INVENTION

1. Field of the Invention

The present invention relates to a shift register, a display device having the shift register and a method of outputting signals in the shift register. More particularly, the present invention relates to a shift register having improved electrical characteristics, a display device having the shift register and a method of outputting signals in the shift register.

2. Description of the Related Art

A flat panel display device includes a liquid crystal display (“LCD”) device, an organic light emitting display (“OLED”) device, or a plasma display (“PD”) panel device, for example. The flat panel display device has various characteristics such as thin thickness, light weight, low driving voltage, and low power consumption, for example.

An arrangement of liquid crystals of the LCD device vary in response to an electric field applied to a liquid crystal layer, and a light transmittance of the liquid crystal layer of the LCD device is changed, thereby displaying an image.

The LCD device generally includes an LCD panel, a gate driving circuit and a data driving circuit. The LCD panel includes the array substrate, a color filter substrate and a liquid crystal layer. The array substrate includes a plurality of gate lines, a plurality of data lines and a plurality of switching elements (e.g., thin film transistors). The color filter substrate correspondingly faces the array substrate. The liquid crystal layer is interposed between the array substrate and the color filter substrate. The gate driving circuit applies a gate signal to the gate lines. The data driving circuit applies a data signal to the data lines.

In order to decrease a size of the LCD device, the gate driving circuit is directly formed on the array substrate. However, when the gate driving circuit is directly formed on the array substrate, a design margin for the gate driving circuit is reduced because a channel length of each of thin film transistors of the gate driving circuit is decreased.

Decreasing the channel length of each of the thin film transistors results in an increase in the deterioration of the thin film transistors and a decrease in the resolution of the LCD device. In addition, the gate signal is delayed in the LCD panel, thus deteriorating image display quality.

### BRIEF SUMMARY OF THE INVENTION

The present invention provides a shift register with improved electrical characteristics.

The present invention also provides a display device having the above-mentioned shift register.

The present invention also provides a method of outputting signals in the above-mentioned shift register.

An exemplary embodiment of a shift register in accordance with the present invention includes a plurality of stages to sequentially output a plurality of output signals. Each of the stages includes a driving part and a discharging part. The driving part includes a driving transistor. The driving transistor has a control electrode, a first electrode, a second electrode and a channel layer. The control electrode receives a start signal or an output signal of a previous stage. The first electrode receives a clock signal. The second electrode outputs an output signal of a present stage. The channel layer has a different length from a channel layer of a driving transistor of the previous stage. The discharging part discharges the output signal of the present stage based on an output signal of a next stage.

Another exemplary embodiment of a shift register in accordance with the present invention includes a plurality of stages to sequentially output a plurality of output signals. Each of the stages includes a driving part, a carry part and a discharging part. The driving part outputs an output signal of a present stage based on one of a start signal and a carry signal of a previous stage, and one of a first clock signal and a second clock signal having a substantially opposite phase to the first clock signal. The carry part includes a carry transistor that has a control electrode, a first electrode, a second electrode and a channel layer. The control electrode receives the one of the start signal and the carry signal of the previous stage. The first electrode receives the one of the first and second clock signals. The second electrode outputs a carry signal of the present stage. The carry signal is electrically independent from the output signal. The channel layer has a different length from a channel layer of a carry transistor of the previous stage. The discharging part discharges the output signal of the present stage based on an output signal of a next stage.

An exemplary embodiment of still another shift register in accordance with the present invention includes a plurality of stages to sequentially output a plurality of output signals. Each of the stages includes a driving part, a carry part, a carry line and a discharging part. The driving part outputs an output signal of a present stage based on one of a start signal and a carry signal of a previous stage, and one of a first clock signal and a second clock signal having a substantially opposite phase to the first clock signal. The carry part outputs a carry signal of the present stage based on the one of the start signal and the carry signal of the previous stage, and the one of the first clock signal and the second clock signal. The carry signal is electrically independent from the output signal. The carry line transmits the carry signal and has a different width from a carry line of the previous stage. The discharging part discharges the output signal of the present stage based on an output signal of a next stage.

An exemplary embodiment of a display device in accordance with the present invention includes a display panel, a shift register and a data driving part. The display panel includes a plurality of gate lines, a plurality of data lines and a plurality of pixels electrically connected to the gate and data lines to display an image. The shift register includes a plurality of stages directly formed on the display panel to sequentially apply a plurality of output signals to the gate lines. Each of the stages includes a driving part and a discharging part. The driving part includes a driving transistor that has a control electrode receiving a start signal or an output signal of a previous stage, a first electrode receiving a clock signal, a second electrode outputting an output signal of a present stage, and a channel layer having a different length from a channel layer of a driving transistor of the previous stage. The discharging part discharges the output signal of the present stage based on an output signal of a next stage. The data driving part applies a plurality of data signals to the data lines.

Another exemplary embodiment of a display device in accordance with the present invention includes a display panel, a shift register and a data driving part. The display panel includes a plurality of gate lines, a plurality of data lines and a plurality of pixels electrically connected to the gate and data lines to display an image. The shift register includes a plurality of stages directly formed on the display panel to sequentially apply a plurality of output signals to the gate lines. Each of the stages includes a driving part, a carry part and a discharging part. The driving part outputs an output signal of a present stage based on one of a start signal and a carry signal of a previous stage, and one of a first clock signal and a second clock signal having a substantially opposite phase to the first clock signal. The carry part includes a carry transistor that has a control electrode receiving the one of the start signal and the carry signal of the previous stage, a first electrode receiving the one of the first and second clock signals, a second electrode outputting a carry signal of the present stage, and a channel layer having a different length from a channel layer of a carry transistor of the previous stage. The carry signal is electrically independent from the output signal. The discharging part discharges the output signal of the present stage based on an output signal of a next stage. The data driving part applies a plurality of data signals to the data lines.

An exemplary embodiment of still another display device in accordance with the present invention includes a display panel, a shift register and a data driving part. The display panel includes a plurality of gate lines, a plurality of data lines, and a plurality of pixels that are electrically connected to the gate and data lines to display an image. The shift register includes a plurality of stages directly formed on the display panel to sequentially apply a plurality of output signals to the gate lines. Each of the stages includes a driving part, a carry part, a carry line and a discharging part. The driving part outputs an output signal of a present stage based on one of a start signal and a carry signal of a previous stage, and one of a first clock signal and a second clock signal having a substantially opposite phase to the first clock signal. The carry part outputs a carry signal of the present stage based on the one of the start signal and the carry signal of the previous stage, and the one of the first clock signal and the second clock signal. The carry signal is electrically independent from the output signal. The carry line transmits the carry signal and has a different width from a carry line of the previous stage. The discharging part discharges the output signal of the present stage based on an output signal of a next stage. The data driving part applies a plurality of data signals to the data lines.

An exemplary embodiment of a method of outputting a plurality of output signals in sequence in a shift register in accordance with the present invention is provided as follows. The shift register has a plurality of stages. Each stage has a driving part including a driving transistor. The driving transistor has a control electrode, a first electrode, a second electrode and a channel layer defined by ends of the first and second electrodes spaced apart from each other. The channel layer is formed with a different length from a channel layer of a driving transistor of the previous stage. One of a start signal and an output signal of a previous stage is received at the first electrode. A clock signal is received at the first electrode. An output signal of a present stage is outputted at the second electrode. The output signal of the present stage is discharged from a discharging part based on an output signal of a next stage.

According to the present invention, the output signals of the shift register are divided into a plurality of groups, and sequentially applied to the gate lines (e.g., the output signals are applied to the gate lines in sequence), so that the driving margin of the shift register is improved.

In addition, the channel length of the driving transistor of each of the stages of each of the gate driving parts is increased, as the number of each of the stages of each of the gate driving parts is increased. Therefore, the maximum current that can be applied to the driving transistor and the charging rate of the capacitor of each of the stages are increased, thus improving the waveform of the output signal.

Furthermore, the channel length of the carry transistor of each of the stages of each of the gate driving parts is increased, as the number of each of the stages of each of the gate driving parts is increased. Therefore, the maximum current that can be applied to the carry transistor is increased, thus improving the waveform of the carry signal.

Also, the width of the carry line of each of the stages of each of the gate driving parts is increased, as the number of each of the stages of each of the gate driving parts is increased. Therefore, the maximum current that can be applied to the carry line is increased, thus improving the waveform of the carry signal.

In addition, the current needed for driving the shift register may be decreased so that the shift register may be more highly integrated.

### BRIEF DESCRIPTION OF THE DRAWINGS

The above and other advantages of the present invention will become more apparent by describing in detail exemplary embodiments thereof with reference to the accompanying drawings, in which:

FIG. 1 is a circuit schematic diagram showing one exemplary embodiment of a stage in accordance with the present invention;

FIG. 2 is a plan view showing a second transistor shown in FIG. 1;

FIG. 3 is a cross-sectional view taken along a line I-I′ shown in FIG. 2;

FIG. 4 is a plan view showing a first gate driving part of the stage shown in FIG. 1;

FIG. 5 is a plan view showing a second gate driving part of the stage shown in FIG. 1;

FIG. 6 is a timing diagram showing an operation of a shift register having the stage shown in FIG. 1;

FIG. 7 is a plan view showing a display device having the stage shown in FIG. 1;

FIG. 8 is a circuit schematic diagram showing another exemplary embodiment of a stage in accordance with the present invention;

FIG. 9 is a plan view showing a carry transistor shown in FIG. 8;

FIG. 10 is a cross-sectional view taken along a line II-II′ shown in FIG. 9;

FIG. 11 is a plan view showing a first gate driving part having the stage shown in FIG. 8;

FIG. 12 is a plan view showing a second gate driving part having the stage shown in FIG. 8;

FIG. 13 is a timing diagram showing an operation of a shift register having the stage shown in FIG. 8;

FIG. 14 is a plan view showing a display device having the stage shown in FIG. 8;

FIG. 15 is a plan view showing an exemplary embodiment of a display device in accordance with the present invention; and

FIG. 16 is a plan view showing a first gate driving part shown in FIG. 15.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

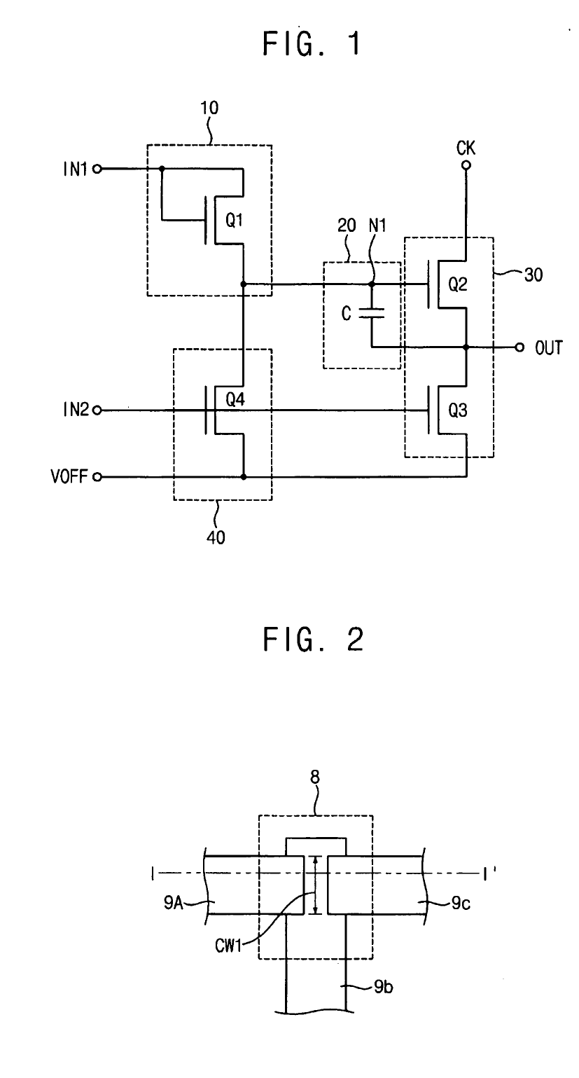

FIG. 1 is a circuit schematic diagram showing one exemplary embodiment of a stage in accordance with the present invention.

Referring to FIG. 1, the stage includes a buffering part 10, a charging part 20, a driving part 30 and a discharging part 40. The stage applies a gate signal (or a scan signal) to a gate line of a liquid crystal display (“LCD”) device based on a scan start signal or an output signal of a previous stage.

The buffering part 10 includes a first transistor Q1. A gate electrode of the first transistor Q1 is electrically connected to a first electrode of the first transistor Q1 and a first input terminal IN1. When the stage is a first stage of a shift register, the scan start signal is applied to the first input terminal IN1. When the stage is not the first stage of the shift register, the output signal of the previous stage is applied to the first input terminal IN1. A second electrode of the first transistor Q1 is electrically connected to a first node N1.

The charging part 20 includes a capacitor C. A first storage electrode of the capacitor C is electrically connected to the first node N1, the second electrode of the first transistor Q1 and the discharging part 40. A second storage electrode of the capacitor C is electrically connected to the driving part 30.

The driving part 30 includes a second transistor Q2 and a third transistor Q3.

A first electrode of the second transistor Q2 is electrically connected to a clock terminal CK. A first clock signal is applied to the clock terminal CK of odd numbered stages, and a second clock signal is applied to the clock terminal CK of even numbered stages. A gate electrode of the second transistor Q2 is electrically connected to the first storage electrode of the capacitor C, the second electrode of the first transistor Q1 and the discharging part 40 through the first node N1. A second electrode of the second transistor Q2 is electrically connected to the second storage electrode of the capacitor C and an output terminal OUT of the present stage.

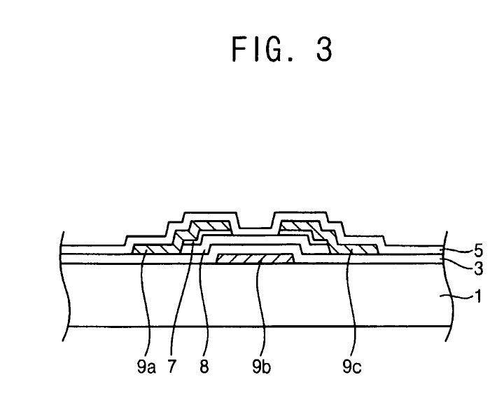

FIG. 2 is a plan view showing the second transistor Q2 shown in FIG. 1. FIG. 3 is a cross-sectional view taken along a line I-I′ shown in FIG. 2.

Referring to FIGS. 2 and 3, the second transistor Q2 is on an insulating substrate 1. The second transistor Q2 includes the gate electrode 9b, the first electrode 9c, the second electrode 9a, a channel layer 8 and an ohmic contact layer 7.

The gate electrode 9b is on the insulating substrate 1. A first insulating layer 3 is on the insulating substrate 1 having the gate electrode 9b so that the gate electrode 9b is electrically insulated from the first and second electrodes 9c and 9a, the channel layer 8 and the ohmic contact layer 7.

The channel layer 8 is on the first insulating layer 3 corresponding to the gate electrode 9b. In FIGS. 2 and 3, the channel layer 8 may include amorphous silicon. Alternatively, the channel layer 8 may include polysilicon. The ohmic contact layer 7 is on the channel layer 8, and includes two patterns spaced apart from each other. For example, the ohmic contact layer 7 includes N+ amorphous silicon. The first and second electrodes 9c and 9a are spaced apart from each other, and on the patterns of the ohmic contact layer 7.

A channel length CW1 is defined by the first and second electrodes 9c and 9a. In particular, the channel length CW1 (FIG. 2) is a length of the channel layer 8 exposed through the first and second electrodes 9c and 9a. The second transistor Q2 of the present stage has a different channel length CW1 from a second transistor Q2 of the previous stage or a next stage. In FIGS. 1 to 3, the channel length CW1 is increased in subsequent stages. Alternatively, the channel length CW1 may decrease in subsequent stages. For example, an electrical mobility of the channel layer 8 is 0.5 cm²/Vs, and a thickness of the channel layer 8 is about 1,000 Å to about 3,000 Å. In addition, the channel length CW1 is increased from about 5,000 μm to about 10,000 μm.

A second insulating layer 5 is on the first insulating layer 3 having the first and second electrodes 9c and 9a and the channel layer 8.

In FIGS. 1 and 3, the channel length CW1 of the second transistor Q2 is changed. Alternatively, a channel length of the first transistor Q1, the third transistor Q3 or the fourth transistor Q4 may also be changed in subsequent stages.

Referring again to FIG. 1, a gate electrode of the third transistor Q3 is electrically connected to a second input terminal IN2. An output signal of the next stage is applied to the second input terminal IN2. A first electrode of the third transistor Q3 is electrically connected to the second storage electrode of the capacitor C, the second electrode of the second transistor Q2 and the output terminal OUT of the present stage. A second electrode of the third transistor Q3 is electrically connected to an off-voltage terminal VOFF.

The discharging part 40 includes a fourth transistor Q4. A gate electrode of the fourth transistor Q4 is electrically connected to the second input terminal IN2. A first electrode of the fourth transistor Q4 is electrically connected to the second electrode of the first transistor Q1, the first storage electrode of the capacitor C and the gate electrode of the second transistor Q2 through the first node N1. A second electrode of the fourth transistor Q4 is electrically connected to the off-voltage terminal VOFF and the second electrode of the third transistor Q3.

In operation, the scan start signal or the output signal of the previous stage is charged in the capacitor C through the first transistor Q1 to turn on the second transistor Q2. When the second transistor Q2 is turned on, the clock signal is applied to the output terminal OUT of the present stage through the channel 8 (shown in FIG. 2) of the second transistor Q2. Therefore, the output signal of the present stage is outputted through the output terminal OUT.

When the output signal of the next stage is applied to the second input terminal IN2, the electric charge stored in the capacitor C is discharged through the channel layer of the third transistor Q3 and the off-voltage terminal VOFF.

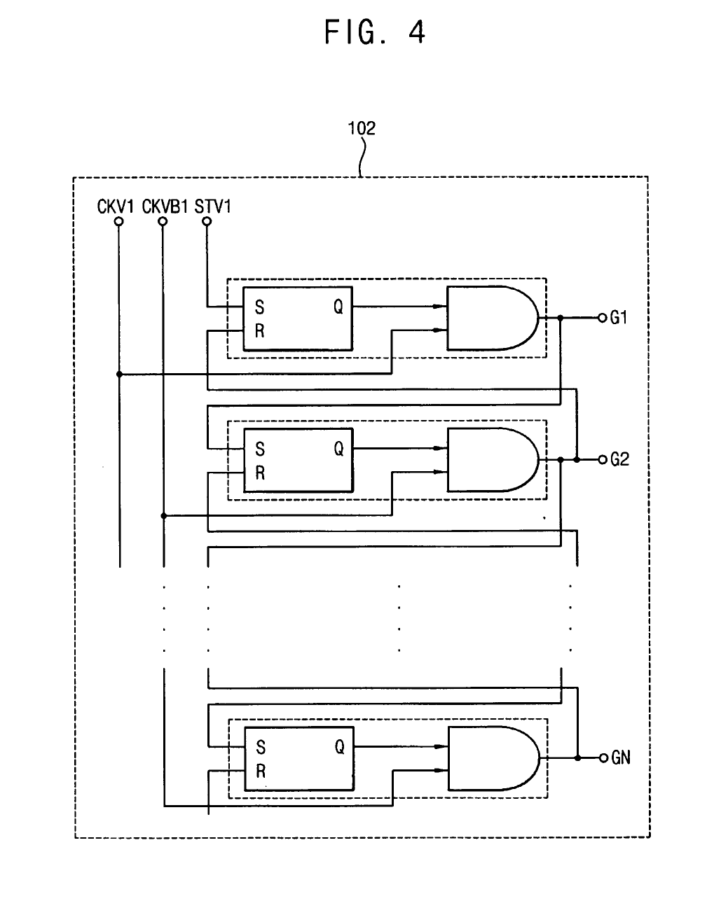

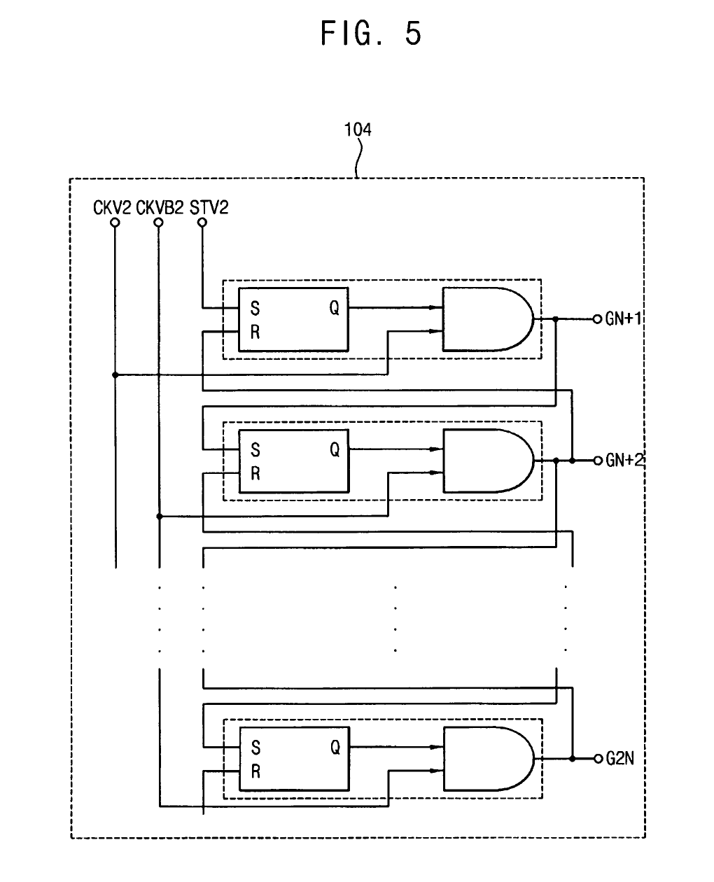

FIG. 4 is a plan view showing a first gate driving part of the stage shown in FIG. 1. FIG. 5 is a plan view showing a second gate driving part of the stage shown in FIG. 1. The first gate driving part 102 and the second gate driving part 104 form a shift register.

Referring to FIGS. 1 to 5, the shift register includes the fist gate driving part 102 and the second gate driving part 104. The first gate driving part 102 includes first, second, . . . , N-th stages. The second gate driving part 104 includes (N+1)-th, (N+2)-th, . . . 2N-th stages.

A channel length CW1 of a second transistor Q2 of each of the stages of the first gate driving part 102 is increased, as the number of each of the stages of the first gate driving part 102 is increased. In addition, a channel length CW1 of a second transistor Q2 of each of the stages of the second gate driving part 104 is also increased, as the number of each of the stages of the second gate driving part 104 is increased. When the channel length CW1 of the second transistor Q2 is increased, a maximum current that can be applied to the second transistor Q2 is correspondingly increased. In addition, a waveform of the output signal and a charging rate of the capacitor C may be changed by maximizing current. In FIGS. 1 to 5, a channel length CW1 of a second transistor Q2 of m-th stage is substantially the same as that of a (N+m)-th stage, wherein m is a natural number from 1 to N.

One S-R latch and one AND-gate may represent each of the stages.

In operation, each of the stages of the first gate driving part 102 is activated by the output signal of the previous stage, and deactivated by the output signal of the next stage. When the S-R latch is activated and the clock signal that is the first clock CKV1 or the second clock CKVB1 is a high level, the AND gate applies the output signal of the present stage to one of first, second, . . . N-th gate lines G1, G2, . . . GN.

Each of the stages of the second gate driving part 104 is activated by the output signal of the previous stage, and deactivated by the output signal of the next stage. When the S-R latch is activated and the clock signal that is the third clock CKV2 or the fourth clock CKVB2 is a high level, the AND gate applies the output signal of the present stage to one of (N+1)-th, (N+2)-th, . . . , 2N-th gate lines GN+1, GN+2, . . . , G2N.

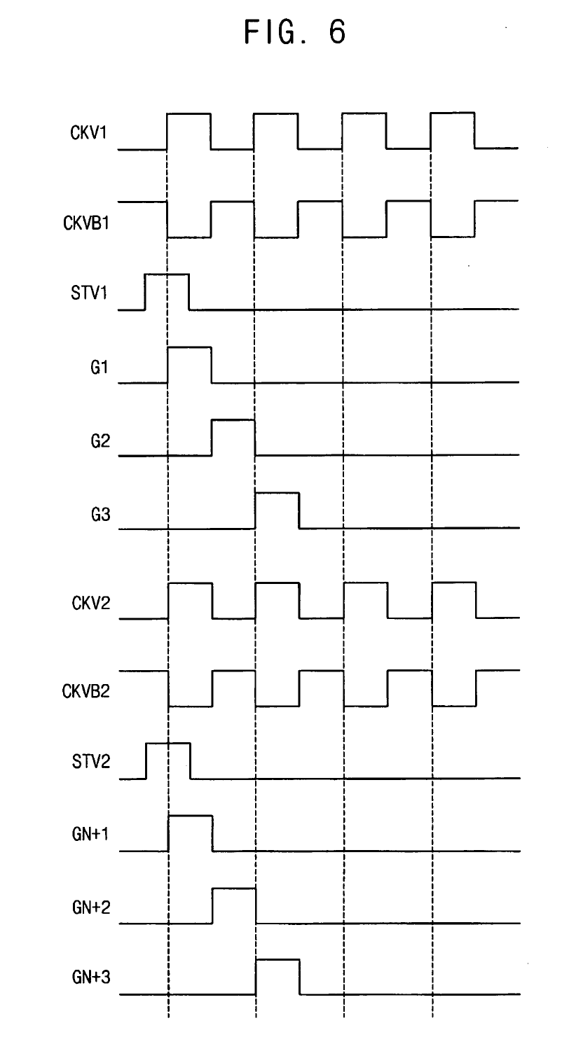

FIG. 6 is a timing diagram showing an operation of a shift register having the stage shown in FIG. 1.

Referring to FIGS. 4 to 6, the first gate driving part 102 is synchronized with the second gate driving part 104.

In particular, the first clock signal CKV1, the second clock signal CKVB1, a first scan start signal STV1 and the first, second, . . . N-th output signals of the first gate driving part 102 are synchronized with the third clock signal CKV2, the fourth clock signal CKVB2, a second scan start signal STV2 and the (N+1)-th, (N+2)-th, 2N-th output signals of the second gate driving part 104.

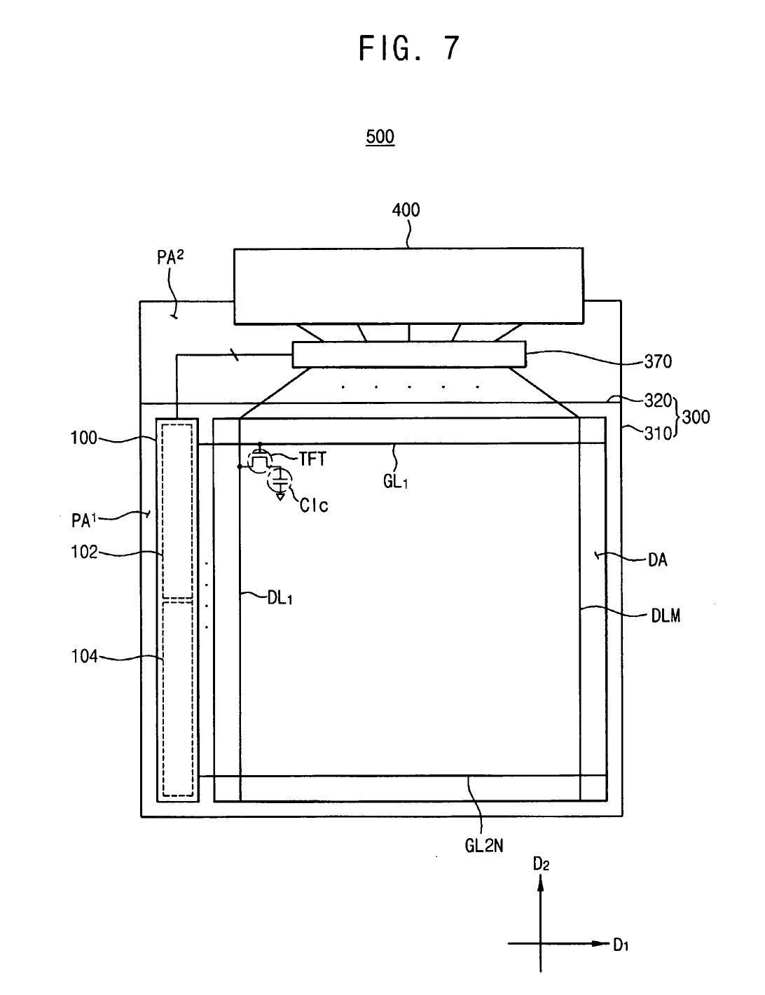

FIG. 7 is a plan view showing a display device having the stage shown in FIG. 1.

Referring to FIGS. 4, 5 and 7, the display device 500 includes the shift register 100, a display panel 300, a data driver 370 and a flexible circuit board 400.

The display panel 300 includes a first substrate 310, a second substrate 320 and a liquid crystal layer (not shown). The second substrate 320 corresponds to the first substrate 310 and is disposed thereover, as illustrated. The liquid crystal layer (not shown) is interposed between the first and second substrates 310 and 320.

The first substrate 310 includes a display region DA, a first peripheral region PA¹ and a second peripheral region PA². An image is displayed in the display region DA. The first and second peripheral regions PA₁ and PA² are adjacent to the display region DA.

A plurality of gate lines GL₁, GL₂, . . . GL2N and a plurality of data lines DL₁, DL₂, . . . , DLM are in the display region DA of the first substrate 310. The gate lines GL₁, GL₂, . . . , GL2N are extended in a first direction D₁. The data lines DL₁, DL₂, DLM cross the gate lines GL₁, GL₂, . . . , GL2N, and are extended in a second direction D₂ that is substantially perpendicular to the first direction D₁. The data lines DL₁, DL₂, . . . , DLM are electrically insulated from the gate lines GL₁, GL₂, . . . GL2N. The gate and data lines GL₁, GL₂, . . . , GL2N and DL₁, DL₂, . . . , DLM define a plurality of pixel regions. The pixel regions are arranged in a matrix shape.

A pixel thin film transistor TFT and a liquid crystal capacitor Clc are in each of the pixel regions. The liquid crystal capacitor Clc is electrically connected to the pixel thin film transistor TFT. A gate electrode of the pixel thin film transistor TFT is electrically connected to one of the gate lines GL₁, GL₂, . . . , GL2N. A second electrode of the pixel thin film transistor TFT is electrically connected to one of the data lines DL₁, DL₂, . . . , DLM. A first electrode of the pixel thin film transistor TFT is electrically connected to the liquid crystal capacitor Clc.

One end portion of each of the gate lines GL₁, GL₂, . . . , GL2N extends toward the first peripheral region PA¹. One end portion of each of the data lines DL₁, DL₂, . . . , DLM extends toward the second peripheral region PA².

The shift register 100 is in the first peripheral region PA¹. The shift register 100 that includes the first and second gate driving parts 102 and 104 applies the first, second, . . . , 2N-th gate signals G1, G2, . . . , G2N to the gate lines GL₁, GL₂, GL2N based on the synchronized signals. The channel length CW1 of the second transistor Q2 (shown in FIG. 1) of each of the stages of each of the first and second gate driving parts 102 and 104 is increased in each of the subsequent stages of each of the first and second gate driving parts 102 and 104. The shift register 100 includes the first and second gate driving parts 102 and 104 so that the output signals G1, G2, . . . , G2N are divided into two groups. The divided output signals G1, G2, . . . , G2N are applied to the gate lines GL₁, GL₂, . . . , GL2N, in sequence. For example, the shift register 100 may be formed from substantially the same layers as the pixel thin film transistors TFT on the first substrate 310. Alternatively, the shift register 100 may be a chip on the first substrate 310.

The data driver 370 is on the second peripheral region PA². The data driver 370 is electrically connected to the data lines DL₁, DL₂, . . . , DLM to apply the data signals to the data lines. For example, the data driver 370 may be a chip on the first substrate 310. Alternatively, the data driver 370 may be formed from substantially the same layers as the pixel thin film transistors TFT.

The flexible circuit board 400 is attached to a portion of the peripheral region PA² so that an externally provided unit (not shown) is electrically connected to the data driver 370 through the flexible circuit board 400. For example, the externally provided unit (not shown) may be a graphic controller.

According to the stage, the shift register having the stage and the display device having the stage shown in FIGS. 1 to 7, the output signals G1, G2, . . . , G2N are divided into the two groups to be applied to the gate lines GL₁, GL₂, . . . , GL2N. When the output signals are not divided, for example, a frequency difference and a period difference between the first output signal G1 and the last output signal G2N may be about 30 Hz and about 33.3 μm. However, in FIGS. 1 to 7, the output signals G1, G2, . . . , G2N are divided into the two groups so that a frequency difference between the first to N-th output signals G1, G2, . . . , GN or between the (N+1)-th to 2N-th output signals GN+1, GN+2, . . . , G2N may be about 15 Hz. In addition, a period difference between the first to N-th output signals G1, G2, . . . , GN or between the (N+1)-th to 2N-th output signals GN+1, GN+2, . . . , G2N may be about 66.7 μm. Therefore, a margin for driving the shift register 100 is increased.

In addition, the channel length CW1 of the second transistor Q2 of each of the stages of each of the first and second gate driving parts 102 and 104 is increased in each of the subsequent stages of each of the first and second gate driving parts 102 and 104. Therefore, the maximum current that can be applied to the second transistor Q2 and the charging rate of the capacitor of each of the stages are increased, and the waveform of the output signal is improved.

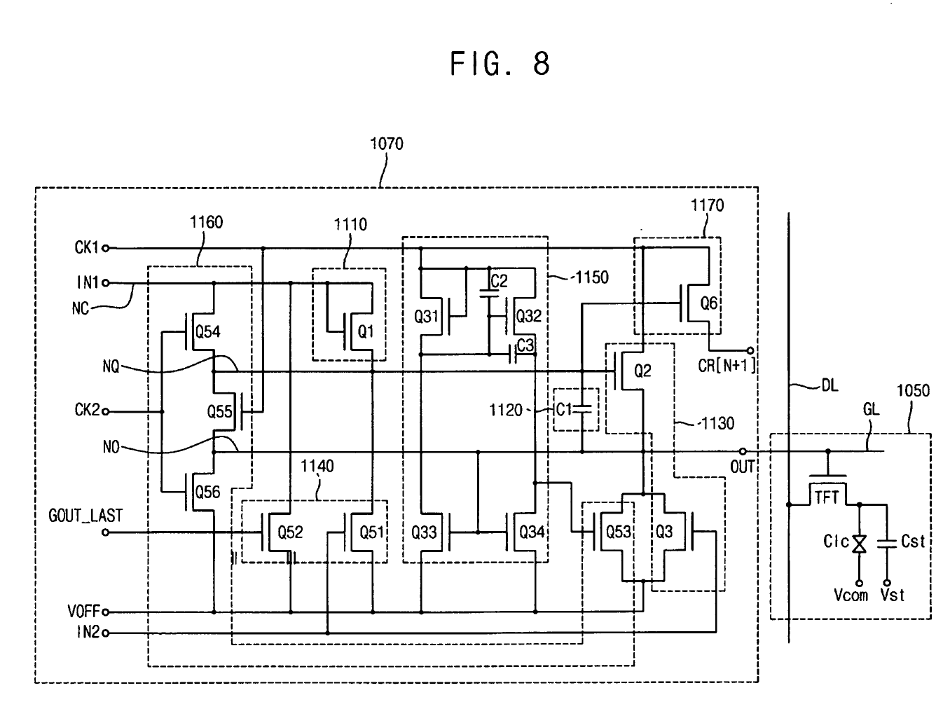

FIG. 8 is a circuit schematic diagram showing another exemplary embodiment of a stage in accordance with the present invention.

Referring to FIG. 8, the stage 1070 is electrically connected to a pixel 1050.

The pixel 1050 includes a pixel thin film transistor TFT, a liquid crystal capacitor Clc and a storage capacitor Cst.

A gate electrode of the pixel thin film transistor TFT is electrically connected to a gate line GL. A first electrode of the pixel thin film transistor TFT is electrically connected to the liquid crystal capacitor Clc and the storage capacitor Cst. A second electrode of the pixel thin film transistor TFT is electrically connected to a data line DL.

The stage 1070 includes a buffering part 1110, a charging part 1120, a driving part 1130, a discharging part 1140, a first holding part 1150, a second holding part 1160 and a carry part 1170. The stage 1070 outputs a gate signal (or a scan signal) to the gate line GL based on a scan start signal or a carry signal of a previous stage.

The buffering part 1110 includes a buffer transistor Q1. A gate electrode of the buffer transistor Q1 is electrically connected to a first electrode of the buffer transistor Q1 and a first input terminal IN1. When the stage is a first stage of a shift register, the scan start signal is applied to the first input terminal IN1. When the stage is not the first stage of the shift register, a carry signal of the previous stage is applied to the first input terminal IN1. A second electrode of the buffer transistor Q1 is electrically connected to the charging part 1120, the driving part 1130, the discharging part 1150 and the holding part 1160. In FIG. 8, the buffer transistor Q1 may include a channel layer (not shown) including hydrogenated amorphous silicon.

The charging part 1120 includes a charging capacitor C1. The scan start signal or the carry signal of the previous stage is stored in the charging capacitor C1. A first storage electrode of the charging capacitor C1 is electrically connected to the second electrode of the buffer transistor Q1 and the charging part 1140. A second storage electrode of the charging capacitor C1 is electrically connected to an output terminal OUT of the present stage.

The driving part 1130 includes a first driving transistor Q2 and a second driving transistor Q3.

A first electrode of the first driving transistor Q2 is electrically connected to a first clock terminal CK1. A first clock signal or a third clock signal is applied to the first clock terminal CK1 of odd numbered stages, and a second clock signal or a fourth clock signal is applied to the first clock terminal CK1 of even numbered stages. A gate electrode of the first driving transistor Q2 is electrically connected to the first storage electrode of the charging capacitor C1, the second electrode of the buffer transistor Q1, the discharging part 1140 and the second holding part 1160. A second electrode of the first driving transistor Q2 is electrically connected to the second electrode of the charging capacitor C1 and an output terminal OUT of the present stage. In FIG. 8, the first driving transistor Q2 may include a channel layer (not shown) including hydrogenated amorphous silicon.

A gate electrode of the second driving transistor Q3 is electrically connected to a second input terminal IN2. The output signal of the next stage is applied to the second input terminal IN2. A first electrode of the second driving transistor Q3 is electrically connected to the second electrode of the charging capacitor C1, the second electrode of the first driving transistor Q2 and the output terminal OUT. A second electrode of the second driving transistor Q3 is electrically connected to the off-voltage terminal VOFF. In FIG. 8, the second driving transistor Q3 may include a channel layer (not shown) including hydrogenated amorphous silicon.

The discharging part 1140 includes a first discharge transistor Q51 and a second discharge transistor Q52. The discharging part 1140 first discharges the electric charge stored in the charging capacitor C1 to the off-voltage terminal VOFF based on an output signal of a next stage. The output signal of the next stage is applied to the discharging part 1140 through the second input terminal IN2. Also, the discharging part 1140 may secondly discharge the electric charge stored in the charging capacitor C1 to the off-voltage terminal VOFF based on an output signal of a last stage. The output signal of the last stage is applied to the discharging part 1140 through the last scan signal terminal GOUT_LAST.

A gate electrode of the first discharge transistor Q51 is electrically connected to the second input terminal IN2. A first electrode of the first discharge transistor Q51 is electrically connected to the first electrode of the charging capacitor C1. A second electrode of the first discharge transistor is electrically connected to the off-voltage terminal VOFF. In FIG. 8, the first discharge transistor Q51 may include a channel layer (not shown) including hydrogenated amorphous silicon.

A gate electrode of the second discharge transistor Q52 is electrically connected to the last scan signal terminal GOUT_LAST. A first electrode of the second discharge transistor Q52 is electrically connected to the charging capacitor C1 through the buffering part 1110. A second electrode of the second discharge transistor Q52 is electrically connected to the off-voltage terminal VOFF. In FIG. 8, the second discharge transistor Q52 may include a channel layer (not shown) including hydrogenated amorphous silicon.

The first holding part 1150 includes a first holding transistor Q31, a second holding transistor Q32, a third holding transistor Q33, a fourth holding transistor Q34, a first holding capacitor C2 and a second holding capacitor C3.

A first electrode of the first holding transistor Q31 is electrically connected to a gate electrode of the first holding transistor Q31 and the first clock terminal CK1. A second electrode of the first holding transistor Q31 is electrically connected to a gate electrode of the second holding transistor Q32. The gate electrode of the second holding transistor Q32 is electrically connected to a first electrode of the second holding transistor Q32 through the first holding capacitor C2, and electrically connected to a second electrode of the second holding transistor Q32 through the second holding capacitor C3. The first electrode of the second holding transistor Q32 is electrically connected to a first electrode of the first holding transistor Q31 and the first clock terminal CK1. The second electrode of the second holding transistor Q32 is electrically connected to the second holding part 1160. In FIG. 8, each of the first holding transistors Q31 may include a channel layer (not shown) including hydrogenated amorphous silicon.

A gate electrode of the third holding transistor Q33 is electrically connected to the output terminal OUT of the present stage, the second holding part 1160 and a gate electrode of the fourth holding transistor Q34. A first electrode of the third holding transistor Q33 is electrically connected to the second electrode of the first holding transistor Q31 and the gate electrode of the second holding transistor Q32. A second electrode of the third holding transistor Q33 is electrically connected to the off-voltage terminal VOFF. In FIG. 8, each of the second and third holding transistors Q32 and Q33 may include a channel layer (not shown) including hydrogenated amorphous silicon.

A gate electrode of the fourth holding transistor Q34 is electrically connected to the output terminal OUT, the second holding part 1160 and the gate electrode of the third holding transistor Q33. A first electrode of the fourth holding transistor Q34 is electrically connected to the second electrode of the second holding transistor Q32 and the second holding part 1160. A second electrode of the fourth holding transistor Q34 is electrically connected to the off-voltage terminal VOFF. In FIG. 8, each of the fourth holding transistors Q34 may include a channel layer (not shown) including hydrogenated amorphous silicon.

The second holding part 1160 includes a fifth holding transistor Q53, a sixth holding transistor Q54, a seventh holding transistor Q55 and an eighth holding transistor Q56 to prevent a floating of the output terminal OUT.

A gate electrode of the fifth holding transistor Q53 is electrically connected to the second electrode of the second holding transistor Q32 and the first electrode of the fourth holding transistor Q34. A first electrode of the fifth holding transistor Q53 is electrically connected to the second electrode of the first driving transistor Q2, the first electrode of the second driving transistor Q3, the second electrode of the charging capacitor C1, a second electrode of the seventh holding transistor Q55 and a first electrode of the eighth holding transistor Q56. A second electrode of the fifth transistor Q53 is electrically connected to the off-voltage terminal VOFF.

A gate electrode of the sixth holding transistor Q54 is electrically connected to a second clock terminal CK2 and a gate electrode of the eighth holding transistor Q56. The second clock signal or the fourth clock signal is applied to the second clock terminal CK2 of the odd numbered stages. The first clock signal or the third clock signal is applied to the second clock terminal CK2 of the even numbered stages. For example, the signal applied to the second clock terminal CK2 has an opposite phase to the signal applied to the first clock terminal CK1. A first electrode of the sixth holding transistor Q54 is electrically connected to the first input terminal IN1, the first electrode of the buffer transistor Q1 and the first electrode of the second discharge transistor Q52. A second electrode of the sixth holding transistor Q54 is electrically connected to a first electrode of the seventh holding transistor Q55, the second electrode of the buffer transistor Q1, the first electrode of the first discharge transistor Q51, the first electrode of the charging capacitor C1, the gate electrode of the first driving transistor Q2 and the carry part 1170.

A gate electrode of the seventh holding transistor Q55 is electrically connected to the first clock terminal CK1. The first electrode of the seventh holding transistor Q55 is electrically connected to the second electrode of the sixth holding transistor Q54, the second electrode of the buffer transistor Q1, the first electrode of the first discharge transistor Q51, the first electrode of the charging capacitor C1, the gate electrode of the first driving transistor Q2 and the carry part 1170. The second electrode of the seventh holding transistor Q55 is electrically connected to a first electrode of the eighth holding transistor Q56 and the output terminal OUT of the present stage.

The gate electrode of the eighth holding transistor Q56 is electrically connected to the second clock terminal CK2 and the gate electrode of the sixth holding transistor Q54. A second electrode of the eighth holding transistor Q56 is electrically connected to the off-voltage terminal VOFF.

When the output signal that is applied to the output terminal OUT of the present stage is a high level, the second and fourth holding transistors Q32 and Q34 pull-down the gate electrode of the fifth holding transistor Q53 to an off-voltage that is applied to the off-voltage terminal VOFF.

When the output signal that is applied to the output terminal OUT of the present stage is a low level, the signal applied to the first clock terminal CK1 is applied to the gate electrode of the fifth holding transistor Q53 through the second holding transistor Q32. In FIG. 8, when the output signal is not the high level, a level of a voltage applied to the gate electrode of the second holding transistor Q32 equals the high level of the signal applied to the first clock terminal CK1 subtracting a threshold voltage of the first holding transistor Q31. That is, when the output signal is not the high level, a signal synchronized with the signal that is applied to the first clock terminal CK1 is applied to the gate electrode of the fifth holding transistor Q53.

When the signal applied to the second clock terminal CK2 is the high level, the off-voltage applied to the off-voltage terminal VOFF is applied to the output terminal OUT through the eighth holding transistor Q56.

The carry part 1170 includes a carry transistor Q6. The carry part 1170 outputs the carry signal of the present stage based on the electric charge stored in the charging capacitor C1 and the first clock terminal CK1.

A gate electrode of the carry transistor Q6 is electrically connected to the second electrode of the buffer transistor Q1. A first electrode of the carry transistor Q6 is electrically connected to the first clock terminal CK1. A second electrode of the carry transistor Q6 outputs the carry signal. The second electrode of the carry transistor Q6 is electrically insulated from the output terminal OUT so that the carry signal has a uniform luminance although the output signal is distorted.

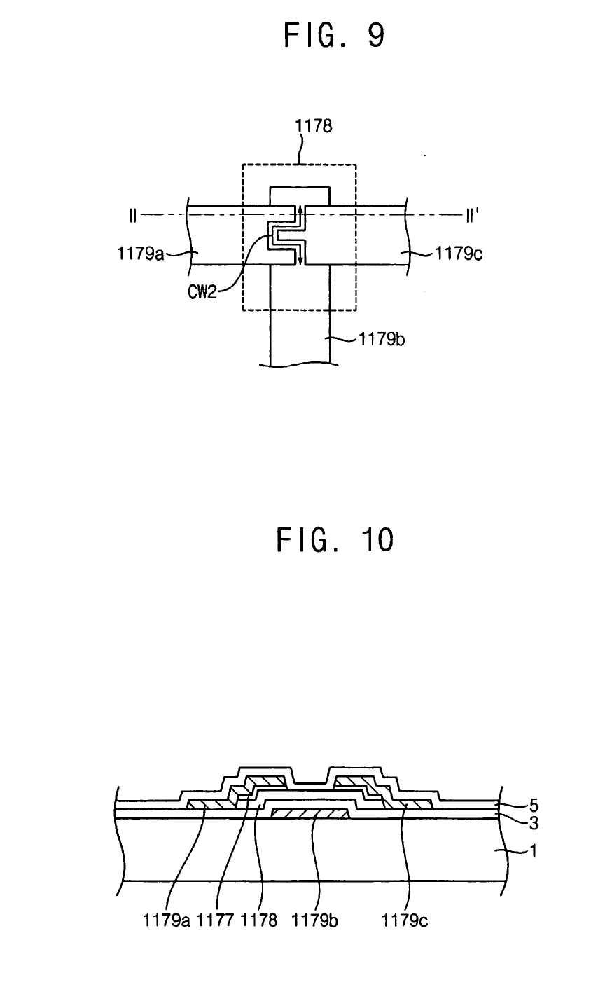

FIG. 9 is a plan view showing the carry transistor Q6 shown in FIG. 8. FIG. 10 is a cross-sectional view taken along a line II-II′ shown in FIG. 9.

Referring to FIGS. 9 and 10, the carry transistor Q6 is on an insulating substrate 1. The carry transistor Q6 includes the gate electrode 1179b, the first electrode 1179c, the second electrode 1179a, a channel layer 1178 and an ohmic contact layer 1177.

The gate electrode 1179b is on the insulating substrate 1. A first insulating layer 3 is on the insulating substrate 1 having the gate electrode 1179b so that the gate electrode 1179b is electrically insulated from the first and second electrodes 1179c and 1179a, the channel layer 1178 and the ohmic contact layer 1177.

The channel layer 1178 is on the first insulating layer 3 corresponding to the gate electrode 1179b. In FIGS. 9 and 10, the channel layer 1178 may include amorphous silicon. Alternatively, the channel layer 1178 may include polysilicon. The ohmic contact layer 1177 is on the channel layer 1178, and includes two patterns spaced apart from each other. The first and second electrodes 1179c and 1179a are spaced apart from each other, and on the patterns of the ohmic contact layer 1177.

A channel length CW2 is defined by the first and second electrodes 1179c and 1179a, respectively. In particular, the channel length CW2 is a length of the channel layer 1178 exposed through the first and second electrodes 1179c and 1179a. In FIGS. 9 and 10, the channel layer 1178 that is exposed through the first and second electrodes 1179c and 1179a may have a serpentine shape when viewed on a plane to increase a length of the channel length CW2. The carry transistor Q6 of the present stage has a different length from a channel length CW2 from a carry transistor Q6 of the previous stage or the next stage. In FIGS. 9 to 10, the length of the channel length CW2 increases in subsequent present stages. Alternatively, the length of the channel length CW2 may decrease in subsequent present stages. For example, an electrical mobility of the channel layer 8 is 0.5 cm²/Vs, and a thickness of the channel layer 1178 is about 1,000 Å to about 3,000 Å. In addition, the length of the channel length CW1 is increased from about 5,000 μm to about 10,000 μm.

A second insulating layer 5 is on the first insulating layer 3 having the first and second electrodes 1179c and 1179a and the channel layer 1178.

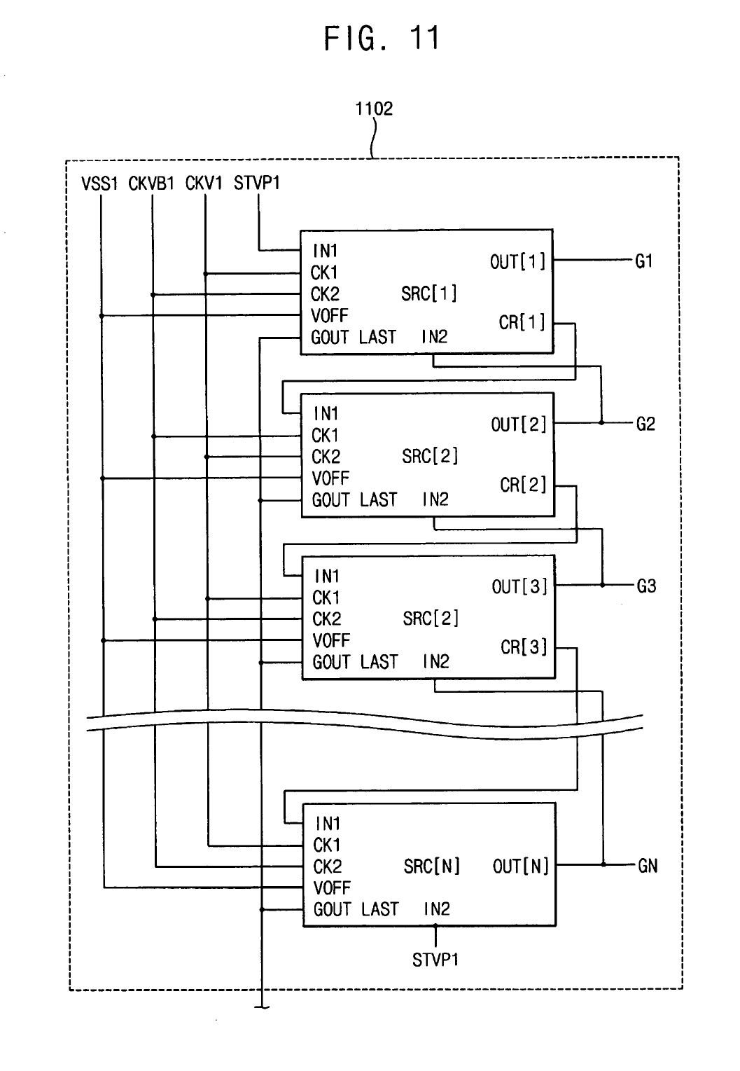

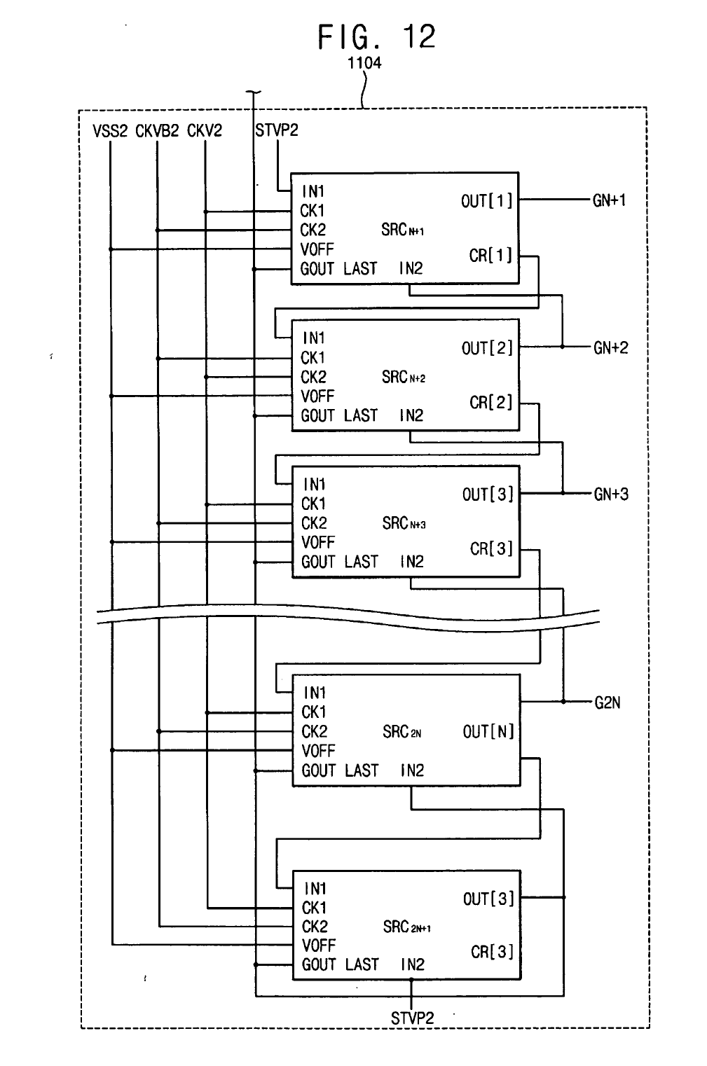

FIG. 11 is a plan view showing a first gate driving part 1102 having the stage shown in FIG. 8. FIG. 12 is a plan view showing a second gate driving part 1104 having the stage shown in FIG. 8. The first gate driving part 1102 and the second gate driving part 1104 form a shift register.

Referring to FIGS. 8 to 12, the shift register includes the fist gate driving part 1102 and the second gate driving part 1104. The first gate driving part 1102 includes first, second, . . . N-th stages SRC[1], SRC[2], . . . , SRC[N]. The second gate driving part 104 includes (N+1)-th, (N+2)-th, . . . , 2N-th stages SRC_{N+1}, SRC_{N+2}, . . . , SRC_{2N} and (2N+1)-th stage SRC_{2N+1}.

A length of a channel length CW2 of a carry transistor Q6 of each of the stages of the first gate driving part 1102 is increased in subsequent stages of the first gate driving part 1102. In addition, a length of a channel length CW2 of a carry transistor Q6 of each of the stages of the second gate driving part 1104 is also increased in subsequent stages of the second gate driving part 1104. When the length of the channel length CW2 of the carry transistor Q6 is increased, a maximum current that can be applied to the carry transistor Q6 is increased. In addition, a waveform of the output signal and a charging rate of the capacitor C may be changed by the maximum current. In FIGS. 8 to 12, a length of a channel length CW2 of a carry transistor Q6 of m-th stage SRCm is substantially the same as that of (N+m)-th stage SRCN+m, wherein m is a natural number from 1 to N.

In operation, the stages SRC[1], SRC[2], . . . , SRC[N] of the first gate driving part 1102 generate first, second, . . . , N-th output signals G1, G2, . . . , GN to the first, second, . . . , N-th gate lines based on a first scan start signal STVP1, a first clock signal CKV1, a second clock signal CKVB1, a first off-voltage VSS1, first to (N−1)-th carry signals CR[1], CR[2], . . . , CR[N−1] and an output signal G2N+1 of the last stage SRC_{2N+1}.

The stages SRC_{N+1}, SRC_{N+2}, . . . , SRC_{2N} of the second gate driving part 1104 generate (N+1)-th, (N+2)-th, . . . 2N-th output signals GN+1, GN+2, . . . , G2N to the (N+1)-th, (N+2)-th . . . , 2N-th gate lines based on a second scan start signal STVP2, a third clock signal CKV2, a fourth clock signal CKVB2, a second off-voltage VSS2, (N+1)-th, (N+2)-th, . . . , (2N−1)-th carry signals CR[N+1], CR[N+2], . . . , CR[2N−1] and the output signal G2N+1 of the last stage SRC_{2N+1}.

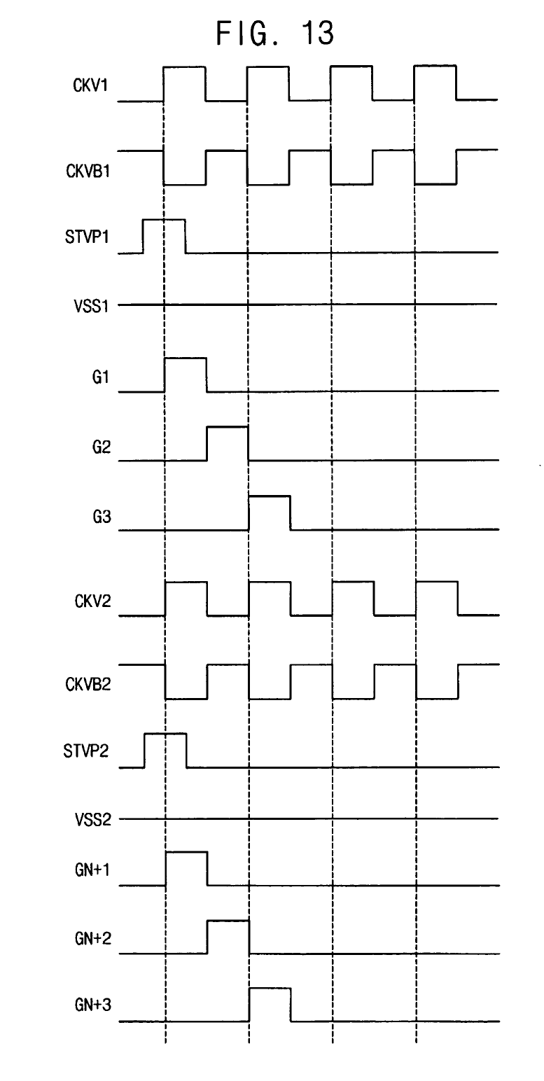

FIG. 13 is a timing diagram showing an operation of a shift register having the stage shown in FIG. 8.

Referring to FIGS. 11 to 13, the first gate driving part 1102 is synchronized with the second gate driving part 1104.

Particularly, the first scan start signal STVP1, the first clock signal CKV1, the second clock signal CKVB1, the first off-voltage VSS1 and the first, second, . . . , (N−1)-th carry signals of the first gate driving part 1102 are synchronized with the second scan start signal STVP2, the third clock signal CKV2, the fourth clock signal CKVB2, the second off-voltage VSS2 and the (N+1)-th, (N+2)-th, . . . , (2N−1)-th carry signals of the second gate driving part 1104.

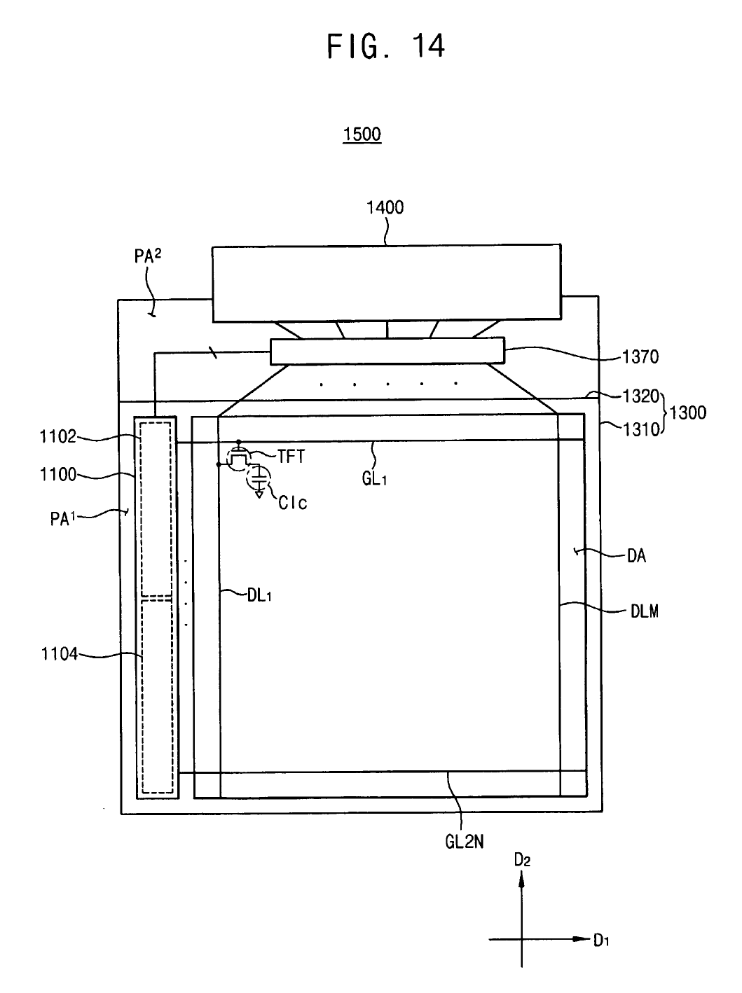

FIG. 14 is a plan view showing a display device having the stage shown in FIG. 8. The display device of FIG. 14 is same as in FIG. 7 except for a shift register thereof. Thus, the same reference numerals will be used to refer to the same or like elements as those described in FIG. 7 and any further explanation concerning the same elements will be omitted.

Referring to FIGS. 11, 12 and 14, the display device 1500 includes the shift register 1100, a display panel 1300, a data driver 1370 and a flexible circuit board 1400.

The display panel 1300 includes a first substrate 1310, a second substrate 1320 and a liquid crystal layer (not shown). The second substrate 1320 corresponds to the first substrate 1310 and is disposed thereover, as illustrated. The liquid crystal layer (not shown) is interposed between the first and second substrates 1310 and 1320.

The first substrate 1310 includes a display region DA, a first peripheral region PA¹ and a second peripheral region PA². An image is displayed in the display region DA. The first and second peripheral regions PA¹ and PA² are adjacent to the display region DA.

A plurality of gate lines GL1, GL2, . . . , GL2N and a plurality of data lines DL₁, DL2, . . . , DLM are in the display region DA of the first substrate 1310. The gate lines GL1, GL2, . . . , GL2N extend in a first direction D1 toward the first peripheral region PA¹. The data lines DL1, DL2, . . . , DLM cross the gate lines GL1, GL2, . . . , GL2N, and extend in a second direction D2 that is substantially perpendicular to the first direction D1 toward the second peripheral region PA².

The length of the channel length CW2 of the carry transistor Q6 (shown in FIG. 8) of each of the stages of each of the first and second gate driving parts 1102 and 1104 is increased in subsequent increasing number of each of the stages of each of the first and second gate driving parts 1102 and 1104. The shift register 1100 includes the first and second gate driving parts 1102 and 1104 (FIGS. 11 and 12, respectively) so that the output signals G1, G2, . . . , G2N are divided into two groups. The divided output signals G1, G2, . . . , G2N are applied to the gate lines GL1, GL2, . . . , GL2N, in sequence. For example, the shift register 1100 may be formed from substantially same layers as the pixel thin film transistors TFT on the first substrate 1310.

According to the shift register having the stage and the display device having the stage shown in FIGS. 8 to 14, the output signals G1, G2, . . . , G2N are divided into the two groups to be applied to the gate lines GL1, GL2, . . . , GL2N. Therefore, a margin for driving the shift register 1100 is increased.

In addition, the length of the channel length CW2 of the carry transistor Q6 of each of the stages of each of the first and second gate driving parts 1102 and 1104 is increased in subsequent increasing number of each of the stages of each of the first and second gate driving parts 1102 and 1104. Therefore, the maximum current that can be applied to the carry transistor Q6 and the charging rate of the capacitor of each of the stages are correspondingly increased, and the waveform of the output signal is improved. Also, a driving voltage of the shift register 1100 may be decreased.

In FIGS. 8 to 14, the length of the channel length CW2 of the carry transistor Q6 of each of the stages of each of the first and second gate driving parts 1102 and 1104 is increased for each of the subsequent stages of each of the first and second gate driving parts 1102 and 1104. Alternatively, a length of the channel length of the first driving transistor Q2 of each of the stages of each of the first and second gate driving parts 1102 and 1104 may be increased for each of the subsequent stages of each of the first and second gate driving parts 1102 and 1104. In addition, a width of a light that transmits each of the carry signals CR[1], CR[2], . . . , CR[2N] of each of the first and second gate driving parts 1102 and 1104 may also be increased for each of the subsequent stages of each of the first and second gate driving parts 1102 and 1104 is increased.

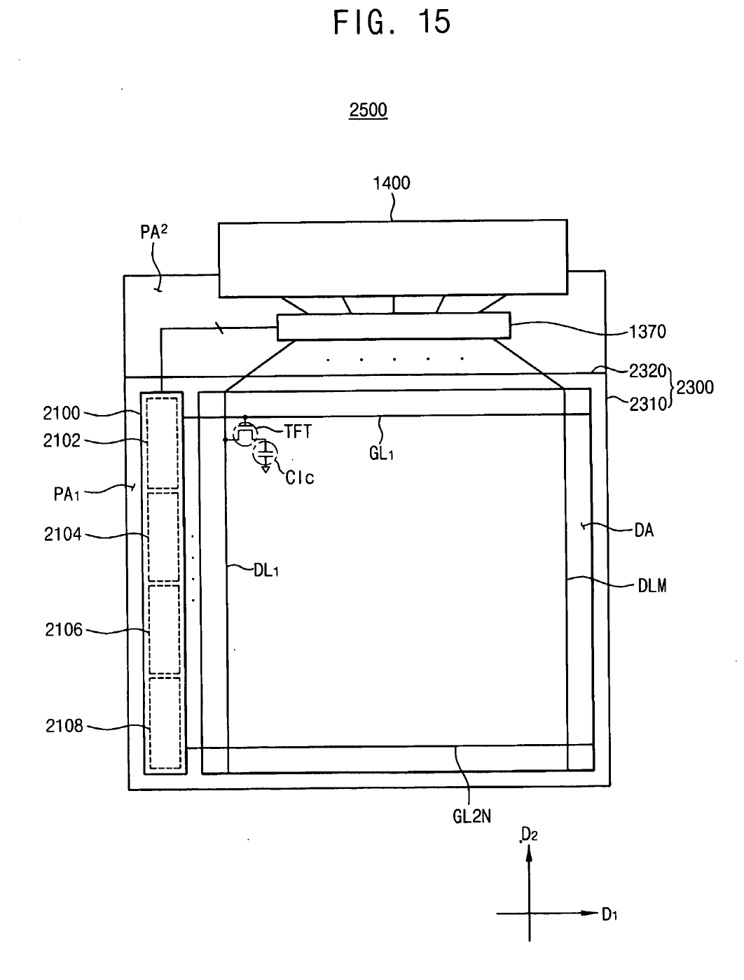

FIG. 15 is a plan view showing a display device in accordance with another embodiment of the present invention. The display device of FIG. 15 is the same as in FIG. 14 except a for shift register thereof. Thus, the same reference numerals will be used to refer to the same or like elements as those described in FIG. 14 and any further explanation concerning the same elements will be omitted.

Referring to FIG. 15, the display device 2500 includes a shift register 2100, a display panel 2300, a data driver 1370 and a flexible circuit board 1400.

The display panel 2300 includes a first substrate 2310, a second substrate 1320 and a liquid crystal layer (not shown). The second substrate 2320 corresponds to the first substrate 2310 and is disposed thereover, as illustrated. The liquid crystal layer (not shown) is interposed between the first and second substrates 2310 and 2320.

The first substrate 2310 includes a display region DA, a first peripheral region PA, and a second peripheral region PA². An image is displayed in the display region DA. The first and second peripheral regions PA₁ and PA² are adjacent to the display region DA.

A plurality of gate lines GL1, GL2, . . . , GL4N and a plurality of data lines DL1, DL2, . . . , DLM are in the display region DA of the first substrate 2310. The gate lines GL1, GL2, . . . , GL4N extend in a first direction D1 toward the first peripheral region PA₁. The data lines DL1, DL2, . . . , DLM cross the gate lines GL1, GL2, . . . , GL4N, and extend in a second direction D2 that is substantially perpendicular to the first direction D1 toward the second peripheral region PA².

The shift register 2100 includes a first gate driving part 2102, a second gate driving part 2104, a third gate driving part 2106 and a fourth gate driving part 2108. The first gate driving part 2102 includes first, second, . . . N-th stages. The second gate driving part 2104 includes (N+1)-th, (N+2)-th, . . . , 2N-th stages. The third gate driving part 2106 includes (2N+1)-th, (2N+2)-th, . . . , 3N-th stages. The fourth gate driving part 2108 includes (3N+1)-th, (3N+2)-th, . . . , 4N-th stages and a (4N+1)-th stage that is a last stage.

The shift register 2100 includes the first, second, third and fourth gate driving parts 2102, 2104, 2106 and 2108 so that the output signals G1, G2, . . . , G4N are divided into four groups. The divided output signals G1, G2, . . . , G4N are applied to the gate lines GL1, GL2, . . . , GL4N, in sequence. For example, the shift register 2100 may be formed from substantially the same layers as the pixel thin film transistors TFT on the first substrate 2310.

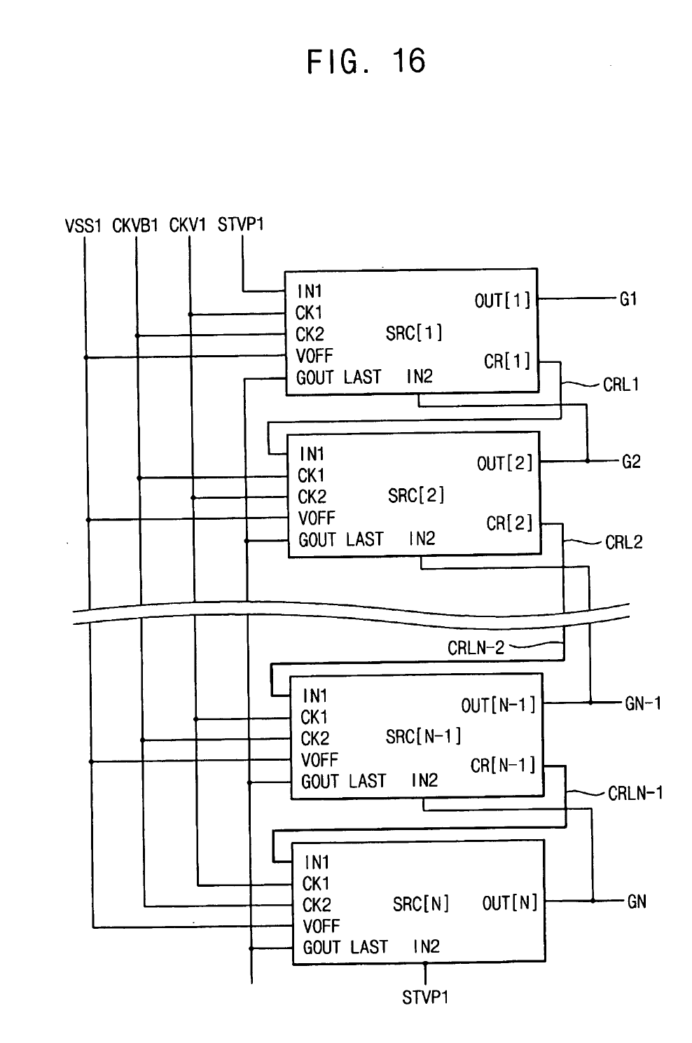

FIG. 16 is a plan view showing the first gate driving part 2102 shown in FIG. 15.

Referring to FIGS. 15 and 16, first, second, . . . 4N-th carry lines CRL1, CRL2, . . . CRL4N transmit first, second, . . . 4N-th carry signals CR1, CR2, . . . , CR4N. A width of each of the carry lines CRL1, CRL2, . . . , CRLN−1 of the first gate driving part 2102 is increased, as the number of each of the stages of the first gate driving part 1102 is subsequently increased. In addition, a width of each of the carry lines CRLN+1, CRLN+2, . . . , CRL2N−1 of the second gate driving part 2104 is increased, as the number of each of the stages of the second gate driving part 1104 is subsequently increased. Furthermore, a width of each of the carry lines CRL2N+1, CRL2N+2, . . . , CRL3N−1 of the third gate driving part 2106 is increased, as the number of each of the stages of the third gate driving part 2106 is subsequently increased. Also, a width of each of the carry lines CRL3N+1, CRL3N+2, . . . , CRL4N−1 of the fourth gate driving part 2108 is increased, as the number of each of the stages of the fourth gate driving part 2108 is subsequently increased. A width of each of the first, (N+1)-th, (2N+1)-th and (3N+1)-th carry lines is about a half of that of each of the (N−1)-th, (2N−1)-th, (3N−1)-th and (4N−1)-th carry lines.

In operation, the stages SRC[1], SRC[2], . . . , SRC[N] of the first gate driving part 2102 apply first, second, . . . N-th output signals G1, G2, . . . , GN to the first, second, . . . , N-th gate lines based on a first scan start signal STVP1, a first clock signal CKV1, a second clock signal CKVB1, a first off-voltage VSS1, first to (N−1)-th carry signals CR1, CR2, . . . , CRN−1 and an output signal of the last stage, in sequence.

The stages SRC[N+1], SRC[N+2], . . . , SRC[2N] of the second gate driving part 2104 sequentially apply (N+1)-th, (N+2)-th, . . . , 2N-th output signals GN+1, GN+2, . . . , G2N to the N+1, N+2, . . . , 2N-th gate lines based on a second scan start signal STVP2, a third clock signal CKV2, a fourth clock signal CKVB2, a second off-voltage VSS2, (N+1)-th, (N+2)-th, . . . , (2N−1)-th carry signals CR[N+1], CR[N+2], CR[2N−1] and the output signal of the last stage.

The stages of the third gate driving part 2106 sequentially apply 2N+1, 2N+2, 3N-th output signals to the 2N+1, 2N+2, . . . , 3N-th gate lines based on a third scan start signal, a fifth clock signal, a sixth clock signal, a third off-voltage, (2N+1)-th, (2N+2)-th, . . . , (3N−1)-th carry signals and the output signal of the last stage.

The stages of the fourth gate driving part 2108 sequentially apply 3N+1, 3N+2, 4N-th output signals to the 3N+1, 3N+2, . . . , 4N-th gate lines based on a fourth scan start signal, a seventh clock signal, an eighth clock signal, a fourth off-voltage, (3N+1)-th, (3N+2)-th, . . . , (4N−1)-th carry signals and the output signal of the last stage.

The signals of the first, second, third and fourth gate driving parts 2102, 2104, 2106 and 2108, respectively, are synchronized with each other.

According to the shift register having the stage and the display device having the stage shown in FIGS. 15 and 16, the output signals G1, G2, . . . , G4N are divided into the four groups to be applied to the gate lines GL1, GL2, . . . , GL4N. Therefore, a margin for driving the shift register 2100 is increased.

In addition, the width of the carry line of each of the stages of each of the first and fourth gate driving parts 2102, 2104, 2106 and 2108 is increased, as the number of each of the stages of each of the first, second, third and fourth gate driving parts 2102, 2104, 2106 and 2108 is subsequently increased. Therefore, the maximum current that can be applied to each of the carry lines and the waveform of the output signal is improved. Also, a current for driving the shift register 2100 may be decreased so that the shift register 2100 may be more highly integrated.

According to the present invention, the output signals of the shift register are divided into a plurality of groups, and sequentially applied to the gate lines, thus improving the driving margin of the shift register.

In addition, the channel length of the driving transistor of each of the stages of each of the gate driving parts is increased, as the number of each of the stages of each of the gate driving parts is subsequently increased. Therefore, the maximum current that can be applied to the driving transistor and the charging rate of the capacitor of each of the stages correspondingly increase, and the waveform of the output signal improves.

Furthermore, the channel length of the carry transistor of each of the stages of each of the gate driving parts is increased, as the number of each of the stages of each of the gate driving parts is subsequently increased. Therefore, the maximum current that can be applied to the carry transistor correspondingly increases, and the waveform of the carry signal improves.

Also, the width of the carry line of each of the stages of each of the gate driving parts is increased, as the number of each of the stages of each of the gate driving parts is subsequently increased. Therefore, the maximum current that can be applied to the carry line increases, and the waveform of the carry signal improves.

In addition, the current for driving the shift register may be decreased so that the shift register may be more highly integrated.

This invention has been described with reference to the exemplary embodiments. It is evident, however, that many alternative modifications and variations will be apparent to those having skill in the art in light of the foregoing description. Accordingly, the present invention embraces all such alternative modifications and variations as falling within the spirit and scope of the appended claims.

What is claimed is:

1. A shift register including a plurality of stages to output a plurality of output signals in sequence, each of the stages comprising:
a driving part including a driving transistor, the driving transistor having:
a control electrode receiving one of a start signal and an output signal of a previous stage;
a first electrode receiving a clock signal;
a second electrode outputting an output signal of a present stage; and
a channel layer having a different length from a channel layer of a driving transistor of the previous stage; and
a discharging part discharging the output signal of the present stage based on an output signal of a next stage.

2. The shift register of claim 1, wherein the length of the channel layer of the driving transistor of each of the stages increases for each subsequent stage relative to a respective previous stage.

3. The shift register of claim 1, wherein the shift register comprises a plurality of gate driving parts synchronized with each other.

4. The shift register of claim 3, wherein the shift register comprises two gate driving parts.

5. The shift register of claim 1, wherein each of the stages further comprises a carry part that includes a carry transistor, the carry transistor including:
a control electrode receiving the start signal or a carry signal of the previous stage;
a first electrode receiving the clock signal;
a second electrode outputting a carry signal of the present stage, the carry signal being electrically independent from the output signal; and
a channel layer having a different length from a channel layer of a carry transistor of the previous stage, and
the control electrode of the driving transistor receiving the start signal or the carry signal of the previous stage.

6. The shift register of claim 5, wherein each of the stages further comprises a carry line transmitting the carry signal, and the carry line has a different width from a carry line of the previous stage.

7. A shift register including a plurality of stages to output a plurality of output signals in sequence, each of the stages comprising:
a driving part outputting an output signal of a present stage based on one of a start signal and a carry signal of a previous stage, and one of a first clock signal and a second clock signal having a substantially opposite phase to the first clock signal;
a carry part including a carry transistor having:
a control electrode receiving the one of the start signal and the carry signal of the previous stage;
a first electrode receiving the one of the first and second clock signals;
a second electrode outputting a carry signal of the present stage, the carry signal electrically independent from the output signal; and
a channel layer having a different length from a channel layer of a carry transistor of the previous stage; and
a discharging part discharging the output signal of the present stage based on an output signal of a next stage.

8. The shift register of claim 7, wherein the length of the channel layer of the carry transistor of each of the stages increases for each subsequent stage relative to a respective previous stage.

9. The shift register of claim 7, wherein the shift register comprises a plurality of gate driving parts synchronized with each other.

10. The shift register of claim 7, wherein the driving part further comprises a driving transistor including:
a control electrode receiving the start signal or the carry signal of the previous stage;
a first electrode receiving the one of the first and second clock signals;
a second electrode outputting the output signal of the present stage; and
a channel layer having a different length from a channel layer of a driving transistor of the previous stage.

11. The shift register of claim 7, wherein each of the stages further comprises a buffering part receiving the one of the start signal and the carry signal of the previous stage.

12. The shift register of claim 7, wherein each of the stages further comprises a charging part storing the one of the start signal and the carry signal of the previous stage.

13. A shift register including a plurality of stages to output a plurality of output signals in sequence, each of the stages comprising:
a driving part outputting an output signal of a present stage based on one of a start signal and a carry signal of a previous stage, and one of a first clock signal and a second clock signal having a substantially opposite phase to the first clock signal;
a carry part outputting a carry signal of the present stage based on the one of the start signal and the carry signal of the previous stage, and the one of the first clock signal and the second clock signal, the carry signal being electrically independent from the output signal;
a carry line transmitting the carry signal, the carry line having a different width from a carry line of the previous stage; and
a discharging part discharging the output signal of the present stage based on an output signal of a next stage.

14. The shift register of claim 13, wherein the length of the carry line of each of the stages increases for each subsequent stage relative to a respective previous stage.

15. The shift register of claim 13, wherein the shift register comprises a plurality of gate driving parts synchronized with each other.

16. The shift register of claim 13, wherein the driving part further comprises a driving transistor including:
a control electrode receiving one of the start signal and the carry signal of the previous stage;
a first electrode receiving the one of the first and second clock signals;
a second electrode outputting the output signal of the present stage; and
a channel layer having a different length from a channel layer of a driving transistor of the previous stage.

17. The shift register of claim 13, wherein the carry part further comprises a carry transistor including:
a control electrode receiving the one of the start signal and the carry signal of the previous stage;
a first electrode receiving the one of the first and second clock signals;
a second electrode outputting the carry signal of the present stage; and
a channel layer having a different length from a channel layer of a carry transistor of the previous stage.

18. A display device comprising:
a display panel including a plurality of gate lines, a plurality of data lines, and a plurality of pixels electrically connected to the gate and data lines to display an image;
a shift register including a plurality of stages directly formed on the display panel to apply a plurality of output signals in sequence to the gate lines, each of the stages comprising:
a driving part including a driving transistor having a control electrode receiving one of a start signal and an output signal of a previous stage, a first electrode receiving a clock signal, a second electrode outputting an output signal of a present stage, and a channel layer having a different length from a channel layer of a driving transistor of the previous stage; and
a discharging part discharging the output signal of the present stage based on an output signal of a next stage; and
a data driving part applying a plurality of data signals to the data lines.

19. The display device of claim 18, wherein the length of the channel layer of each of the stages increases for each subsequent stage relative to a respective previous stage.

20. The display device of claim 18, wherein the shift register comprises a plurality of gate driving parts synchronized with each other.

21. A display device comprising:
a display panel including a plurality of gate lines, a plurality of data lines, and a plurality of pixels electrically connected to the gate and data lines to display an image;
a shift register including a plurality of stages directly formed on the display panel to apply a plurality of output signals in sequence to the gate lines, each of the stages comprising:
a driving part outputting an output signal of a present stage based on one of a start signal and a carry signal of a previous stage, and one of a first clock signal and a second clock signal having a substantially opposite phase to the first clock signal;
a carry part including a carry transistor having a control electrode receiving the one of the start signal and the carry signal of the previous stage, a first electrode receiving the one of the first and second clock signals, a second electrode outputting a carry signal of the present stage, and a channel layer having a different length from a channel layer of a carry transistor of the previous stage, the carry signal electrically independent from the output signal; and
a discharging part discharging the output signal of the present stage based on an output signal of a next stage; and
a data driving part applying a plurality of data signals to the data lines.

22. The display device of claim 21, wherein the length of the channel layer of each of the stages increases as the number of each of the stages is increased.

23. The display device of claim 21, wherein the shift register comprises a plurality of gate driving parts synchronized with each other.

24. A display device comprising:
a display panel including a plurality of gate lines, a plurality of data lines, and a plurality of pixels electrically connected to the gate and data lines to display an image;
a shift register including a plurality of stages directly formed on the display panel to apply a plurality of output signals in sequence to the gate lines, each of the stages comprising:
a driving part outputting an output signal of a present stage based on one of a start signal and a carry signal of a previous stage, and one of a first clock signal and a second clock signal having a substantially opposite phase to the first clock signal;
a carry part outputting a carry signal of the present stage based on the one of the start signal and the carry signal of the previous stage, and the one of the first clock signal and the second clock signal, the carry signal being electrically independent from the output signal;
a carry line transmitting the carry signal, the carry line having a different width from a carry line of the previous stage; and
a discharging part discharging the output signal of the present stage based on an output signal of a next stage; and
a data driving part applying a plurality of data signals to the data lines.

25. The display device of claim 24, wherein the width of the carry line of each of the stages increases for each subsequent stage relative to a respective previous stage.

26. The display device of claim 24, wherein the shift register comprises a plurality of gate driving parts synchronized with each other.

27. A method of outputting a plurality of output signals in sequence in a shift register having a plurality of stages, each stage having a driving part including a driving transistor, the driving transistor having a control electrode, a first electrode, a second electrode and a channel layer defined by ends of the first and second electrodes spaced apart from each other, the method comprising:
forming the channel layer with a different length from a channel layer of a driving transistor of the previous stage;
receiving one of a start signal and an output signal of a previous stage at the first electrode;
receiving a clock signal at the first electrode;
outputting an output signal of a present stage at the second electrode; and
discharging the output signal of the present stage from a discharging part based on an output signal of a next stage.

28. The method of claim 27, further comprising increasing the length of the channel layer of the driving transistor of each of the stages for each subsequent stage relative to a respective previous stage.
